(19) United States
(12) Patent Application Publication
(10) Pub. No.: US 2026/0277585 A1
(43) Pub. Date: Sep. 17, 2026

(54) ELECTRONIC DEVICE AND UPDATING METHOD FOR ELECTRONIC DEVICE

(71) Applicant: ILI TECHNOLOGY CORP., Hsinchu County (TW)

(72) Inventors: Kuo-Hsiang Hung, Hsinchu County (TW); Cheng Hsuan Wu, Hsinchu County (TW); Hsiang Chin Lin, Hsinchu County (TW); Jian-Kao Chen, Hsinchu County (TW); Min Nan Hsieh, Hsinchu County (TW)

(73) Assignee: ILI TECHNOLOGY CORP., Hsinchu County (TW)

(21) Appl. No.: 19/238,548

(22) Filed: Jun. 16, 2025

(30) Foreign Application Priority Data
Mar. 11, 2025 (TW) 114108898

(51) Int. Cl. G06F 8/65; G09G 5/00

(52) U.S. Cl. CPC G06F 8/65; G09G 5/003

(57) ABSTRACT

An electronic device and an updating method for the electronic device are provided. The electronic device includes a processor, a display unit, a memory circuit, and a timing controller. The processor converts an update code into code display data when an update command is obtained. The memory circuit stores code data. The timing controller operates based on the code data. The timing controller generates a timing corresponding to the code display data when the update command is obtained. The display unit displays an image corresponding to the code display data in a first specific display area according to a timing of the code display data. The timing controller captures the code display data corresponding to the first specific display area according to the update command, converts the code display data back into the update code, and updates the code data of the memory circuit using the update code.

### CROSS-REFERENCE TO RELATED APPLICATION

This application claims the priority benefit of Taiwan application serial no. 114108898, filed on March 11, 2025. The entirety of the above-mentioned patent application is hereby incorporated by reference herein and made a part of this specification.

### BACKGROUND

### Technical Field

The disclosure relates to an electronic device and an updating method for the electronic device.

### DESCRIPTION OF RELATED ART

An electronic device may have a display unit and a timing controller. The timing controller operates based on code data stored in a memory, thereby controlling the display unit. When the code data is updated, an operator must disassemble the electronic device to update the code data or replace the memory. Therefore, the time length of the conventional updating operation is very long.

It can be seen that how to shorten the updating time length of the code data of the timing controller is one of the research focuses of persons skilled in the art.

### SUMMARY

The disclosure provides an electronic device and an updating method for the electronic device, which can shorten an updating time length of code data of a timing controller.

In an embodiment of the disclosure, an electronic device includes a processor, a display unit, a memory circuit, and a timing controller. The processor converts an update code into code display data when an update command is obtained. The memory circuit stores code data. The timing controller operates based on the code data. The timing controller is coupled to the processor, the memory circuit, and the display unit. The timing controller transmits the code display data according to a display channel disposed between the timing controller and the processor and generates a timing corresponding to the code display data when the update command is obtained. The display unit displays an image corresponding to the code display data in a first specific display area according to the timing of the code display data. The timing controller captures the code display data corresponding to the first specific display area according to the update command, converts the code display data back into the update code, and updates the code data of the memory circuit using the update code.

In an embodiment of the disclosure, an updating method is used for an electronic device. The electronic device includes a processor, a display unit, a memory circuit, and a timing controller. The memory circuit stores code data. The timing controller operates based on the code data. The updating method includes the following steps. An update code is converted into code display data by the processor when an update command is obtained. The code display data is provided to the timing controller via a display channel. The code display data corresponding to a first specific display area of the display unit is captured according to the update command by the timing controller. The code display data is converted back into the update code by the timing controller. The code data of the memory circuit is updated using the update code by the timing controller.

Based on the above, the update code is converted into the code display data. The timing controller captures the code display data corresponding to the first specific display area of the display unit, and converts the code display data back into the update code. It should be noted that the display channel has a faster transmission speed. In this way, the updating time length of the code data of the memory circuit can be greatly shortened.

### BRIEF DESCRIPTION OF THE DRAWINGS

FIG. 1 is a schematic diagram of an electronic device according to an embodiment of the disclosure.

FIG. 2 is a flowchart of an operating method according to an embodiment of the disclosure.

FIG. 3 is a schematic diagram of an electronic device according to an embodiment of the disclosure.

FIG. 4 is a schematic diagram of a specific display area according to an embodiment of the disclosure.

FIG. 5 is a schematic diagram of an electronic device according to an embodiment of the disclosure.

FIG. 6 is a schematic diagram of a specific display area according to an embodiment of the disclosure.

### DESCRIPTION OF THE EMBODIMENTS

Some embodiments of the disclosure will be described in detail with reference to the drawings. For the reference numerals cited in the following description, when the same reference numerals appear in different drawings, the reference numerals will be regarded as referring to the same or similar elements. The embodiments are only a part of the disclosure and do not disclose all possible implementations of the disclosure. More specifically, the embodiments are merely examples within the claims of the disclosure.

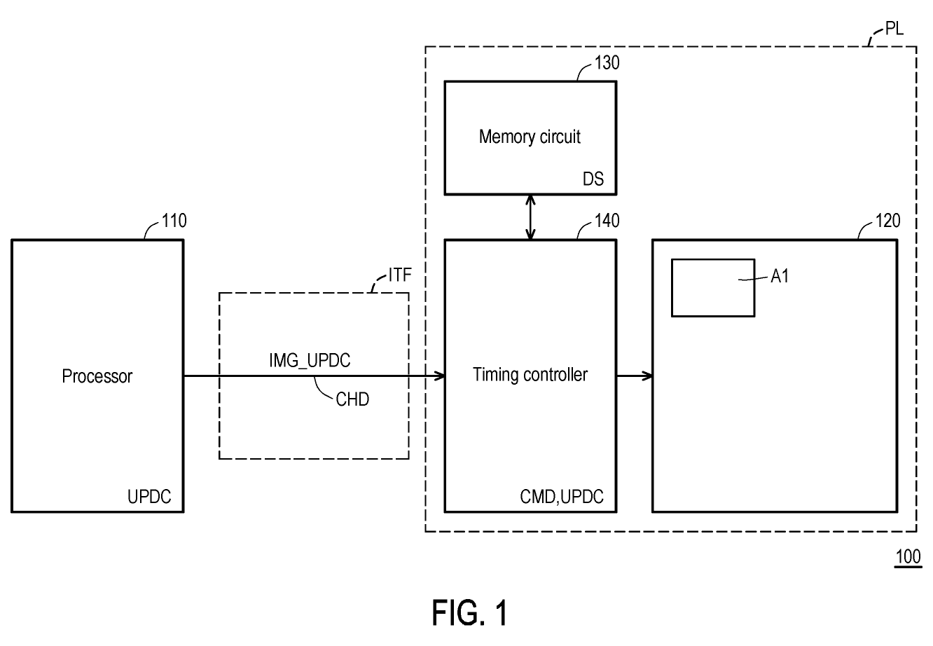

Please refer to FIG. 1. FIG. 1 is a schematic diagram of an electronic device according to an embodiment of the disclosure. In the embodiment, an electronic device 100 includes a processor 110, a display unit 120, a memory circuit 130, and a timing controller 140. When the processor 110 obtains an update command CMD, the processor 110 converts an update code UPDC into code display data IMG_UPDC. The memory circuit 130 stores code data DS. The timing controller 140 is coupled to the processor 110, the display unit 120, and the memory circuit 130. The timing controller 140 operates based on the code data DS stored in the memory circuit 130. A display channel CHD is disposed between the timing controller 140 and the processor 110 to transmit the code display data IMG_UPDC. The timing controller 140 generates a timing corresponding to the code display data IMG_UPDC. The display unit 120 displays an image corresponding to the code display data IMG_UPDC in a specific display area A1 according to the timing of the code display data IMG_UPDC.

In the embodiment, the timing controller 140 captures the code display data IMG_UPDC corresponding to the specific display area A1 according to the update command CMD. The timing controller 140 converts the code display data IMG_UPDC back into the update code UPDC, and updates the code data DS of the memory circuit 130 using the update code UPDC.

It is worth mentioning here that the update code UPDC is converted into the code display data IMG_UPDC and is provided to the timing controller 140. The timing controller 140 captures the code display data IMG_UPDC corresponding to the specific display area A1 of the display unit 120, and converts the code display data IMG_UPDC back into the update code UPDC. The display channel CHD has a fast transmission speed. Therefore, the time length required for the timing controller 140 to receive the update code UPDC can be significantly shortened. In this way, the updating time length of the code data DS of the memory circuit 130 can also be greatly shortened.

In the embodiment, the timing controller 140 receives the code display data IMG_UPDC based on a reception manner of display data. The timing controller 140 may receive the code display data IMG_UPDC from the processor 110 via the display channel CHD of an interface ITF. Therefore, the timing controller 140 may complete receiving the code display data IMG_UPDC in a single frame period. Therefore, without disassembling the electronic device 100, the process from receiving the update command CMD to completing the update of the code data DS can be quickly and easily completed.

For example, the update code UPDC may be a signal conforming to a bin file format (but the disclosure is not limited thereto). The processor 110 converts the update code UPDC into the code display data IMG_UPDC conforming to an image file format. The image file format may be a bmp file format (but the disclosure is not limited thereto). The processor 110 may include a first signal format converter (not shown). The first signal format converter converts the update code UPDC conforming to the bin file format into the code display data IMG_UPDC conforming to the bmp file format.

The timing controller 140 obtains the position of the specific display area A1 according to the update command CMD, thereby capturing the code display data IMG_UPDC corresponding to the position of the specific display area A1 in display data. The timing controller 140 may include a second signal format converter (not shown). The second signal format converter converts the code display data IMG_UPDC conforming to the bmp file format into the update code UPDC conforming to the bin file format.

In the embodiment, the update command CMD is generated by the processor 110. After receiving the update command CMD, the timing controller 140 captures the received code display data IMG_UPDC according to the update command CMD.

In the embodiment, the electronic device 100 may be a personal computer or a notebook computer. The display unit 120, the memory circuit 130, and the timing controller 140 may be integrated into a display panel PL. The processor 110 may be integrated into a host computer. In some embodiments, the electronic device 100 may be a portable device with a display function. The processor 110, the display unit 120, the memory circuit 130, and the timing controller 140 are located on the same substrate.

In the embodiment, the processor 110 is, for example, a graphics processing unit (GPU), a central processing unit (CPU), other programmable general-purpose or specific-purpose microprocessors, digital signal processors (DSP), programmable controllers, application specific integrated circuits (ASIC), programmable logic devices (PLD), other similar devices, or a combination of these devices.

In the embodiment, the display unit 120 may be a device providing a display function, such as a liquid crystal display (LCD), a light-emitting diode (LED) display, or an organic light-emitting diode (OLED) display.

In the embodiment, the memory circuit 130 may be any type of data storage medium known to persons skilled in the art. For example, the memory circuit 130 may be an electrically erasable programmable read-only memory (EEPROM) or a flash memory.

In the embodiment, the timing controller 140 may be implemented by any type of display controller known to persons skilled in the art.

In the embodiment, in a conversion operation of the processor 110 converting the update code UPDC into the code display data IMG_UPDC, the processor 110 may perform a cyclic redundancy check (CRC) operation on the update code UPDC. In some embodiments, the processor 110 may generate an error detection code according to the CRC operation. In some embodiments, the processor 110 may convert the error detection code into error detection display data. When the processor 110 determines that the error detection display data converted back into the error detection code is erroneous, it indicates that an error occurs in the update code UPDC. The processor 110 may re-execute the update command CMD in the next frame period.

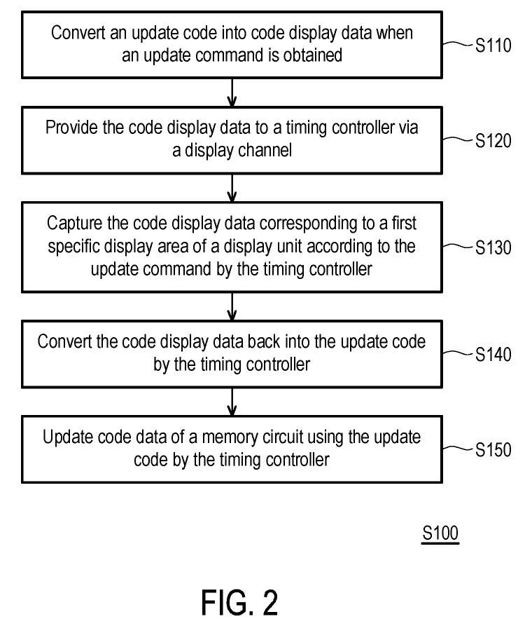

Please refer to FIG. 1 and FIG. 2. FIG. 2 is a flowchart of an operating method according to an embodiment of the disclosure. In the embodiment, an operating method S100 is applicable to the electronic device 100. The operating method S100 includes steps S110 to S150. In step S110, when the update command CMD is obtained, the processor 110 converts the update code UPDC into the code display data IMG_UPDC. In step S120, the processor 110 provides the code display data IMG_UPDC to the timing controller 140 via the display channel CHD. In step S130, the timing controller 140 captures the code display data IMG_UPDC corresponding to the specific display area A1 according to the update command CMD. In step S140, the timing controller 140 converts the code display data IMG_UPDC back into the update code UPDC. The implementation details of steps S110 to S130 have been clearly described in the embodiment of FIG. 1, so there will be no reiteration. Next, the timing controller 140 updates the code data DS of the memory circuit 130 using the update code UPDC in step S150.

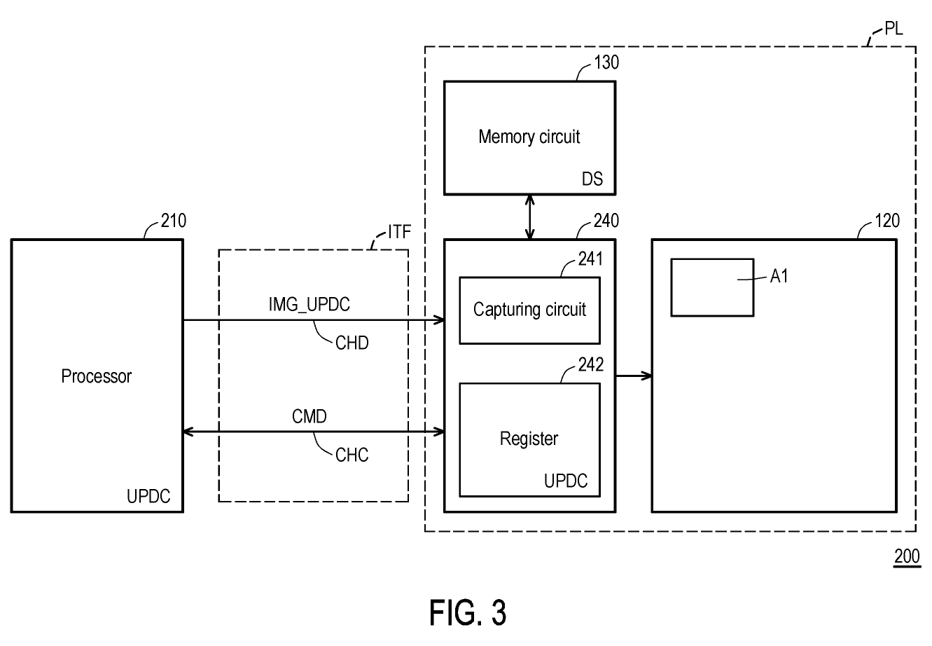

Please refer to FIG. 3. FIG. 3 is a schematic diagram of an electronic device according to an embodiment of the disclosure. In the embodiment, an electronic device 200 includes a processor 210, a display unit 120, a memory circuit 130, and a timing controller 240. The processor 210 generates the update code UPDC. The processor 210 converts the update code UPDC into the code display data IMG_UPDC. In the embodiment, the processor 210 is connected to the timing controller 240 via the interface ITF. The interface ITF includes the display channel CHD and a communication channel CHC. The processor 210 provides the code display data IMG_UPDC to the timing controller 240 via the display channel CHD, and provides the update command CMD to the timing controller 240 via the communication channel CHC.

In the embodiment, the timing controller 240 includes a capturing circuit 241 and a register 242. The capturing circuit 241 receives the update command CMD. The capturing circuit 241 obtains the position of the specific display area A1 according to the update command CMD, and captures the code display data IMG_UPDC corresponding to the position of the specific display area A1. In other words, the capturing circuit 241 may capture the code display data IMG_UPDC from single frame display data already received by the timing controller 240 according to the update command CMD.

The timing controller 240 converts the code display data IMG_UPDC captured by the capturing circuit 241 back into the update code UPDC, and stores the update code UPDC in the register 242. The timing controller 240 updates the code data DS of the memory circuit 130 with the update code UPDC stored in the register 242.

In the embodiment, when the update of the code data DS is completed, the timing controller 240 may notify the processor 210 that the update of the code data DS is completed via the communication channel CHC. Therefore, the processor 210 may obtain an update result of the code data DS.

It should be noted that if the timing controller 240 receives the update code UPDC via the communication channel CHC. The timing controller 240 must take a considerable amount of time to receive the update code UPDC. Based on the operation of receiving the update code UPDC via the communication channel CHC, the updating time length may take about tens of seconds or even several minutes.

In the embodiment, the processor 210 converts the update code UPDC into the code display data IMG_UPDC. The code display data IMG_UPDC is provided to the timing controller 240 via the display channel CHD. Therefore, the transmission of the code display data IMG_UPDC may be completed in the single frame period. Therefore, from receiving the update command CMD to completing the update of the code data DS may be completed within a few seconds or even within 4 seconds.

For example, the interface ITF may be an embedded display port (eDP) or display port (DP) interface. Therefore, the display channel CHD may be a main link channel. The communication channel CHC may be an auxiliary (aux) channel. For example, the interface ITF may be a low-voltage differential signaling (LVDS) interface. Therefore, the display channel CHD may be an LVDS channel. The communication channel CHC may be an I2C channel.

In the embodiment, the electronic device 200 may be applicable to the operating method S100 shown in FIG. 2.

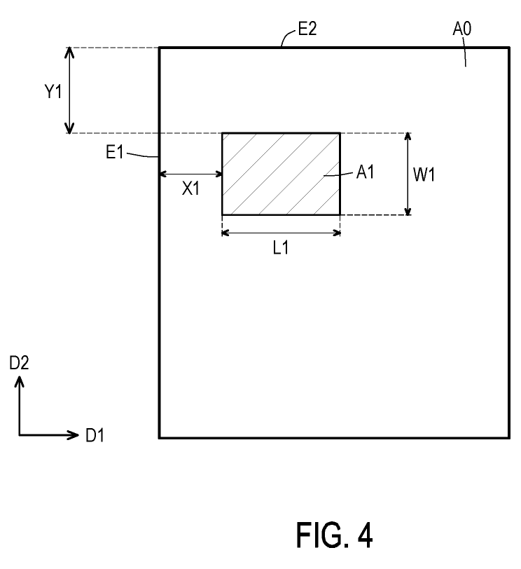

Please refer to FIG. 3 and FIG. 4. FIG. 4 is a schematic diagram of a specific display area according to an embodiment of the disclosure. In the embodiment, the capturing circuit 241 obtains the position of the specific display area A1 according to the update command CMD. More specifically, the update command CMD indicates parameters X1, Y1, L1, and W1 of the specific display area A1 in a display area A0. The display area A0 has edges E1 and E2. The edge E2 is adjacent to the edge E1. The edge E1 extends along a direction D2. The edge E2 extends along a direction D1. The parameter X1 indicates the distance between the edge E1 of the display area A0 and the specific display area A1 in the direction D1. The parameter Y1 indicates the distance between the edge E2 of the display area A0 and the specific display area A1 in the direction D2. The parameter L1 indicates the length of the specific display area A1 in the direction D1. The parameter W1 indicates the length of the specific display area A1 in the direction D2. Based on the parameters X1, Y1, L1, and W1, the capturing circuit 241 may obtain the position (or the range) of the specific display area A1. Therefore, the capturing circuit 241 may capture the code display data IMG_UPDC corresponding to the position of the specific display area A1 according to the parameters X1, Y1, L1, and W1.

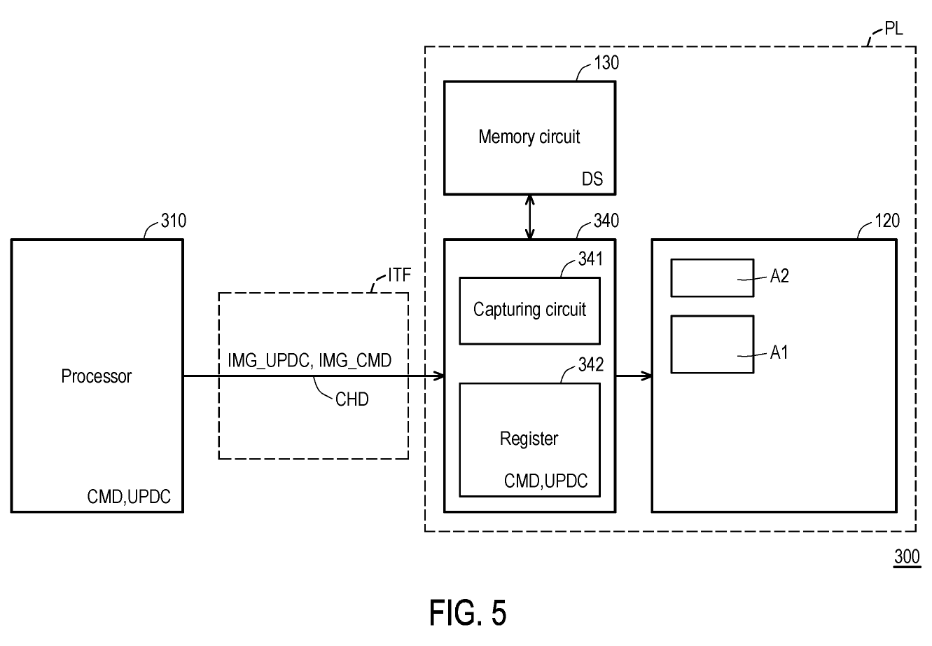

Please refer to FIG. 5. FIG. 5 is a schematic diagram of an electronic device according to an embodiment of the disclosure. In the embodiment, an electronic device 300 includes a processor 310, a display unit 120, a memory circuit 130, and a timing controller 340. The processor 310 generates the update code UPDC. The processor 310 converts the update code UPDC into the code display data IMG_UPDC, and converts the update command CMD into command display data IMG_CMD. In the embodiment, the processor 310 is connected to the timing controller 340 via the interface ITF. The interface ITF includes the display channel CHD. The processor 310 provides the code display data IMG_UPDC and the command display data IMG_CMD to the timing controller 340 via the display channel CHD.

In the embodiment, the timing controller 340 generates the timing corresponding to the code display data IMG_UPDC and a timing corresponding to the command display data IMG_CMD. The display unit 120 displays the image corresponding to the code display data IMG_UPDC in the specific display area A1 according to the timing of the code display data IMG_UPDC. The display unit 120 displays an image corresponding to the code display data IMG_CMD in a specific display area A2 according to the timing of the command display data IMG_CMD.

In the embodiment, the timing controller 340 includes a capturing circuit 341 and a register 342. The capturing circuit 341 captures the command display data IMG_CMD corresponding to the position of the specific display area A2. For example, at least part of the command display data IMG_CMD has a command identification code that may be identified by the capturing circuit 341. The capturing circuit 341 identifies data corresponding to the position of the specific display area A2. Once the data corresponding to the specific display area A2 includes the command identification code, the capturing circuit 341 captures the command display data IMG_CMD corresponding to the position of the specific display area A2.

In the embodiment, the timing controller 340 receives the command display data IMG_CMD captured by the capturing circuit 341. The timing controller 340 converts the command display data IMG_CMD back into the update command CMD. The timing controller 340 stores the update command CMD in the register 342. Next, the capturing circuit 341 obtains the position of the specific display area A1 according to the update command CMD, and captures the code display data IMG_UPDC corresponding to the position of the specific display area A1.

The timing controller 340 converts the code display data IMG_UPDC captured by the capturing circuit 341 back into the update code UPDC, and stores the update code UPDC in the register 342. The timing controller 340 updates the code data DS of the memory circuit 130 with the update code UPDC stored in the register 342.

In the embodiment, when the update of the code data DS is completed, the timing controller 340 may control the display unit 120 to display a notification screen showing that the update of the code data DS is completed. Therefore, a user may know the update result of the code data DS. For example, when the update of the code data DS is completed, the display unit 120 is controlled to display the notification screen in an on-screen display (OSD) manner.

In the embodiment, the display channel CHD may be a main link channel or a LVDS channel.

In the embodiment, the electronic device 300 may be applicable to the operating method S100 shown in FIG. 2.

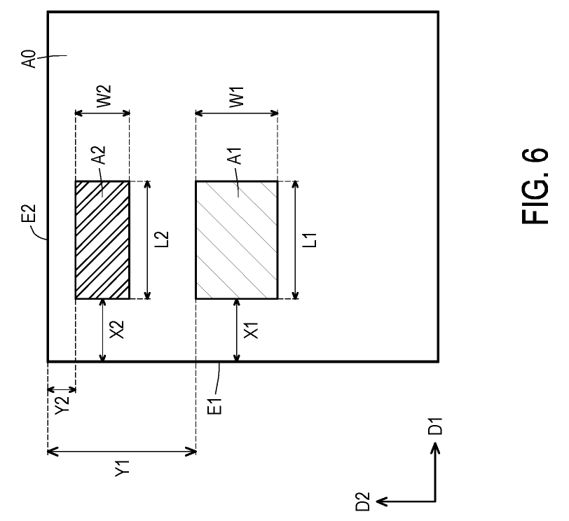

Please refer to FIG. 5 and FIG. 6. FIG. 6 is a schematic diagram of a specific display area according to an embodiment of the disclosure. In the embodiment, the capturing circuit 341 may obtain the position of the specific display area A2 according to parameters X2, Y2, L2, and W2 of the specific display area A2 in the display area A0. The parameter X2 indicates the distance between the edge E1 of the display area A0 and the specific display area A2 in the direction D1. The parameter Y2 indicates the distance between the edge E2 of the display area A0 and the specific display area A2 in the direction D2. The parameter L2 indicates the length of the specific display area A2 in the direction D2. The parameter W2 indicates the length of the specific display area A2 in the direction D2. Based on the parameters X2, Y2, L2, and W2, the capturing circuit 241 may obtain the position (or the range) of the specific display area A2. Therefore, the capturing circuit 241 may capture the command display data IMG_CMD corresponding to the position of the specific display area A2 according to the parameters X2, Y2, L2, and W2.

In addition, the capturing circuit 341 also obtains the position of the specific display area A1 according to the update command CMD. The update command CMD indicates the parameters X1, Y1, L1, and W1 of the specific display area A1 in the display area A0. The parameter X1 indicates the distance between the edge E1 of the display area A0 and the specific display area A1 in the direction D1. The parameter Y1 indicates the distance between the edge E2 of the display area A0 and the specific display area A1 in the direction D2. The edge E2 is adjacent to the edge E1. The parameter L1 indicates the length of the specific display area A1 in the direction D1. The parameter W1 indicates the length of the specific display area A1 in the direction D2. Based on the parameters X1, Y1, L1, and W1, the capturing circuit 241 may obtain the position (or the range) of the specific display area A1. Therefore, the capturing circuit 241 may capture the code display data IMG_UPDC corresponding to the position of the specific display area A1 according to the parameters X1, Y1, L1, and W1.

In the embodiment, the specific display area A1 and the specific display area A2 do not overlap with each other.

In the embodiment, the specific display area A1 is adjacent to or not adjacent to the specific display area A2. The specific display area A1 and the specific display area A2 are arranged along the direction D2. The specific display area A2 is located between the specific display area A1 and the edge E2. However, the disclosure is not limited to the arrangement manner of the specific display areas A1 and A2.

In summary, the update code is converted into the code display data and is provided to the timing controller. The timing controller captures the code display data corresponding to the first specific display area of the display unit, and converts the code display data back into the update code. The display channel has a faster transmission speed. Therefore, the time length required for the timing controller to receive the code display data can be significantly shortened. In this way, the updating time length of the code data of the memory circuit can also be greatly shortened.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An electronic device, comprising:
a processor, configured to convert an update code into code display data when an update command is obtained;
a memory circuit, configured to store code data;
a timing controller, configured to operate based on the code data and coupled to the processor, the memory circuit, and a display unit, wherein a display channel is disposed between the timing controller and the processor to transmit the code display data and generate a timing corresponding to the code display data; and
the display unit, configured to display an image corresponding to the code display data in a first specific display area according to the timing of the code display data,
wherein the timing controller captures the code display data corresponding to the first specific display area according to the update command, converts the code display data back into the update code, and updates the code data of the memory circuit using the update code.

2. The electronic device according to claim 1, wherein the processor provides the update command to the timing controller via a communication channel.

3. The electronic device according to claim 1, wherein the timing controller comprises:
a capturing circuit, configured to obtain a position of the first specific display area according to the update command, and capture the code display data corresponding to the position of the first specific display area.

4. The electronic device according to claim 1, wherein the timing controller comprises:
a register, wherein the timing controller stores the update code in the register, and updates the code data of the memory circuit with the update code stored in the register.

5. The electronic device according to claim 2, wherein the timing controller notifies the processor that update of the code data is completed via the communication channel when the update of the code data is completed.

6. The electronic device according to claim 1, wherein the processor converts the update command into command display data, and provides the code display data and the command display data to the timing controller via a display channel.

7. The electronic device according to claim 6, wherein the display unit displays an image corresponding to the command display data in a second specific display area.

8. The electronic device according to claim 7, wherein the first specific display area and the second specific display area do not overlap with each other.

9. The electronic device according to claim 7, wherein the timing controller comprises:
a capturing circuit, configured to capture the command display data corresponding to a position of the second specific display area,
wherein the timing controller converts the command display data back into the update command, and
wherein the capturing circuit obtains a position of the first specific display area according to the update command, and captures the code display data corresponding to the position of the first specific display area.

10. The electronic device according to claim 6, wherein the timing controller comprises:
a register, wherein the timing controller stores the update code and the update command in the register, and updates the code data of the memory circuit with the update code stored in the register.

11. The electronic device according to claim 6, wherein the timing controller controls the display unit to display a notification screen showing that update of the code data is completed when the update of the code data is completed.

12. The electronic device according to claim 1, wherein the processor performs a cyclic redundancy check operation on the update code to generate an error detection code, and converts the error detection code into error detection display data in a conversion operation of the processor converting the update code into the code display data.

13. The electronic device according to claim 12, wherein when the error detection display data converted back into the error detection code is erroneous, the processor re-executes the update command in a next frame period.

14. An updating method for an electronic device, wherein the electronic device comprises a processor, a display unit, a memory circuit, and a timing controller, wherein the memory circuit stores code data, and the timing controller operates based on the code data, the updating method comprising:
converting an update code into code display data by the processor when an update command is obtained;
providing the code display data to the timing controller via a display channel;
capturing the code display data corresponding to a first specific display area of the display unit according to the update command by the timing controller;
converting the code display data back into the update code by the timing controller; and
updating the code data of the memory circuit using the update code by the timing controller.

15. The updating method according to claim 14, further comprising:
providing the update command to the timing controller via a communication channel.

16. The updating method according to claim 15, wherein the timing controller comprises a capturing circuit, and the step of capturing the code display data corresponding to the first specific display area of the display unit according to the update command by the timing controller comprises:
obtaining a position of the first specific display area according to the update command, and capturing the code display data corresponding to the position of the first specific display area by the capturing circuit.

17. The updating method according to claim 15, further comprising:
generating the update command by the processor; and
notifying the processor that update of the code data is completed via the communication channel by the timing controller when the update of the code data is completed.

18. The updating method according to claim 14, further comprising:
converting the update command into command display data; and
providing the code display data and the command display data to the timing controller via the display channel.

19. The updating method according to claim 18, further comprising:
displaying the command display data in a second specific display area by the display unit.

20. The updating method according to claim 19, wherein the first specific display area and the second specific display area do not overlap with each other.

21. The updating method according to claim 19, wherein the timing controller comprises a capturing circuit, and the step of capturing the code display data corresponding to the first specific display area of the display unit according to the update command by the timing controller comprises:
capturing the command display data corresponding to a position of the second specific display area by the capturing circuit;
converting the command display data back into the update command by the timing controller; and
obtaining a position of the first specific display area according to the update command, and capturing the code display data corresponding to the position of the first specific display area by the capturing circuit.

22. The updating method according to claim 18, further comprising:
controlling the display unit to display a notification screen showing that update of the code data is completed by the timing controller when the update of the code data is completed.

23. The updating method according to claim 14, further comprising:
performing a cyclic redundancy check operation on the update code to generate an error detection code, and converting the error detection code into error detection display data by the processor in a conversion operation of converting the update code into the code display data.

24. The updating method according to claim 23, further comprising:
re-executing the update command in a next frame period by the processor when the error detection code is erroneous.
